(19) United States
(12) Patent Application Publication
(10) Pub. No.: US 2014/0007175 A1
(43) Pub. Date: Jan. 2, 2014

(54) METHOD AND APPARATUS FOR ESTIMATING WIRELESS CHANNEL STATUS USING ADDITIONAL INFORMATION, AND METHOD FOR ADJUSTING CODING RATE IN WIRELESS NETWORK USING METHOD AND APPARATUS

(71) Applicants: Yong Ju Cho, Seoul (KR); Ji Hun Cha, Daejeon-si (KR)

(72) Inventors: Yong Ju Cho, Seoul (KR); Ji Hun Cha, Daejeon-si (KR)

(73) Assignee: ELECTRONICS AND TELECOMMUNICATIONS RESEARCH INSTITUTE, Daejeon-si (KR)

(21) Appl. No.: 14/005,297

(22) PCT Filed: Mar. 16, 2012
(86) PCT No.: PCT/KR2012/001935

§ 371 Date: Sep. 16, 2013

(30) Foreign Application Priority Data
Mar. 16, 2011 (KR) 10-2011-0023234
Jul. 12, 2011 (KR) 10-2011-0069001
Jan. 31, 2012 (KR) 10-2012-0010044
Mar. 15, 2012 (KR) 10-2012-0026393

(51) Int. Cl. H04N 21/6379

(52) U.S. Cl. CPC H04N 21/6379
USPC 725/116

(57) ABSTRACT

The invention relates to method for estimating wireless channel status in wireless network, which is to be performed by client device connected to server for transmitting a video packet stream through a wired/wireless network, comprising: a step of estimating a bit error rate using additional information on a received video packet; and a step of estimating the channel capacity of the wireless network using the estimated bit error rate. The server receives, from the client device, feedback on the estimated channel capacity information or channel condition information of the wireless network, and adjusts the optimal video coding rate or the optimal source coding rate in a wireless network. Accordingly, the deterioration in the video quality of the video stream being received in the client device in real-time may be prevented to thereby improve the quality of service (QoS) of the video being received through a wireless network.

### TECHNICAL FIELD

The present invention relates to methods of estimating a wireless channel status.

### BACKGROUND ART

In a wireless environment, many bit errors occur due to weak signal strength, which causes packet loss. In order to overcome the above-mentioned problem related to real time video transmission, a rate control using forward error correction (FEC) has been introduced.

In order to reduce this packet loss in the wireless environment, it is required to estimate link quality or a channel condition. Particularly, for real time video transmission, it is necessary to accurately estimate wireless channel capacity in real time. The reason is that a wireless link condition and link quality may be varied according to interference, fading, a multi-path effect, mobility, and the like, which significantly changes channel capacity.

That is, in order to set a channel coding rate for providing improved video quality at the time of real time video transmission, it is very important to accurately estimate and predict the wireless channel condition.

For example, in the case of viewing a multimedia content stream through a WLAN (IEEE 802.11b) wireless network installed in an office, significant deterioration may occur in the multimedia content stream due to influence of a channel environment such as interference, or the like, by an access point (AP) positioned at another office.

As a technology of estimating link quality or a channel condition according to the related art, there is a wireless LAN protocol (Conventional Protocol: ‘CON protocol’) of discarding a packet having one or more residue error (an MAC layer error). In the wireless LAN protocol, link quality or channel capacity is estimated using a packet error rate (PER).

In the case of the related art as described above, since the link quality or the channel capacity is predicted using the packet error rate (PER) rather than a bit error rate (BER), accuracy of the prediction is low, such that channel adaptability is low. Therefore, preferable wireless video quality is not secured.

Meanwhile, when only signal strength information of a received video packet is used in order to estimate a bit error rate (BER) of a video packet transmitted in real time, in the case of the video packet transmitted in real time through a wireless network, since maximum signal strength and minimum signal strength are changed according to the wireless network (802.11b, 802.11g, 802.11n, WiMax, LET, or the like), absolute signal strength information does not have an important meaning.

### DISCLOSURE

### Technical Problem

The present invention provides methods for estimating a wireless channel condition and apparatuses for estimating a channel condition in a wireless network using side information including signal strength information, wireless network information, and modulation scheme information in the wireless network.

The present invention also provides a coding rate controlling method and apparatus in a wireless network of controlling a video coding rate and a channel coding rate in the wireless network by predicting an optimal video coding rate and channel coding rate in the wireless network using information on an estimated channel condition in the wireless network.

### Technical Solution

In an aspect, a wireless channel condition estimating method in a wireless network, the method being performed in a client apparatus connected to a server that transmits video packet stream through a wired or wireless network, the method includes: estimating a bit error rate (BER) using side information on received video packet; and estimating channel capacity of the wireless network using the estimated BER, wherein the side information includes signal strength information, modulation scheme information and wireless network information on the wireless network connected to the client apparatus. The signal strength information may be provided from at least one of a PHY layer and an MAC layer of the client apparatus. The estimated channel capacity may be fed-back from the client apparatus to the server. The wireless channel condition estimating method may further include: detecting maximum signal strength information and minimum signal strength information in signal strengths of video packets received during a predetermined adaptation period; estimating representative signal strength information with respect to the video packets received during the predetermined adaptation period; dividing the signal strength section into a plurality of sections including at least one transition section; and determining that the representative signal strength for each of the video packets received during the predetermined adaptation period belongs to which of the divided signal strength sections such that a signal strength section information is generated. The maximum signal strength information, the minimum signal strength information, the representative signal strength information, and the generated signal strength section information may be included in the side information. The side information may further include information on the number of packets transmitted through the wireless network. The side information may be fed-back from the client apparatus to the server.

In another aspect, a client apparatus, connected to a server that transmits video packet stream through a wired or wireless network, for estimate a wireless channel condition in a wireless network, the client apparatus includes: a channel estimator configured to estimate a bit error rate (BER) using side information on received video packet and configured to estimate channel capacity of the wireless network using the estimated BER; and a decoding unit configured to set a channel coding rate based on the estimated channel capacity to perform channel-coding on the video packets received through the wireless network and decode the video on which the channel-coding is performed, wherein the side information includes signal strength information, modulation scheme information and wireless network information on the wireless network connected to the client apparatus. The channel estimator may detect maximum signal strength information and minimum signal strength information in signal strengths of video packets received during a predetermined adaptation period, may estimate representative signal strength information with respect to the video packets received during the predetermined adaptation period, may divide the signal strength section into a plurality of sections including at least one transition section, and may determine that the representative signal strength for each of the video packets received during the predetermined adaptation period belongs to which of the divided signal strength sections such that a signal strength section information is generated.

In still another aspect, a coding rate controlling method in a wireless network, the method being performed in a server, connected to a client apparatus through a wired or wireless network, to transmit video packet stream, the method includes: receiving estimated channel capacity fed-back from the client apparatus to predict channel capacity using the fed-back estimated channel capacity; and controlling a video coding rate and a channel coding rate based on the predicted channel capacity, wherein the estimated channel capacity is estimated using side information including signal strength information, modulation scheme information and wireless network information on the wireless network connected to the client apparatus.

### Advantageous Effects

As set forth above, according to the exemplary embodiments of the present invention, through cross layer approach, a client apparatus estimates a bit error rate (BER) in a wireless network using side information signal strength information, modulation scheme information and wireless network information provided from PHY/MAC layers in the wireless network, and estimates channel capacity or a channel condition in the wireless network using the estimated BER, and a server receives the estimated channel capacity information or channel condition information in the wireless network fed-back from the client apparatus, controls an optimal video coding rate or an optimal source coding rate in the wireless network, and performs channel-coding by applying a differential rate to each video frame (an I-frame, a P-frame, and a B-frame) using a low density parity check (LDPC) code obtained based on the controlled optimal video coding rate or the controlled optimal source coding rate to transmit a video stream to the client apparatus. Therefore, video quality loss of the video stream received in the client apparatus in real time is reduced, thereby making it possible to improve reception quality (QoS) of the video received through the wireless network.

### DESCRIPTION OF DRAWINGS

FIG. 1 is a block diagram describing rate adaptation in a wireless network according to an exemplary embodiment of the present invention.

FIG. 2 is a flow chart describing a wireless channel condition estimating method performed in a client apparatus and a coding rate controlling method in a wireless network performed in a server according to the exemplary embodiment of the present invention.

FIG. 3 is a graph showing a rate distortion (RD) function for a video signal.

FIG. 4 is a graph showing a relationship between a signal to noise ratio (SNR) and a good packet rate for describing to which of divided signal strength sections (Low, Transition, and Strong) the representative signal strength corresponds.

FIG. 5 is a conceptual diagram showing a case in which packet loss and a bit error are present with respect to wireless channels of Case 1 and Case 2.

FIG. 6 is a conceptual diagram in which a case of using only information on the number of packet losses is compared with a case of using signal strength information in terms of throughput improvement in the case of applying FEC to packets of Case 1 of FIG. 5.

FIGS. 7 to 9 are, respectively, graphs showing a correlation between BER and SNR in 802.11a, 802.11g, WiMax wireless networks.

### MODE FOR INVENTION

According to exemplary embodiments of the present invention, a method (1) of predicting an optimal video/channel rate in a wireless network using a video quality distortion estimating function and a differential rate applying method of a video frame for reducing video quality loss using a low density parity check (LDPC) code are suggested.

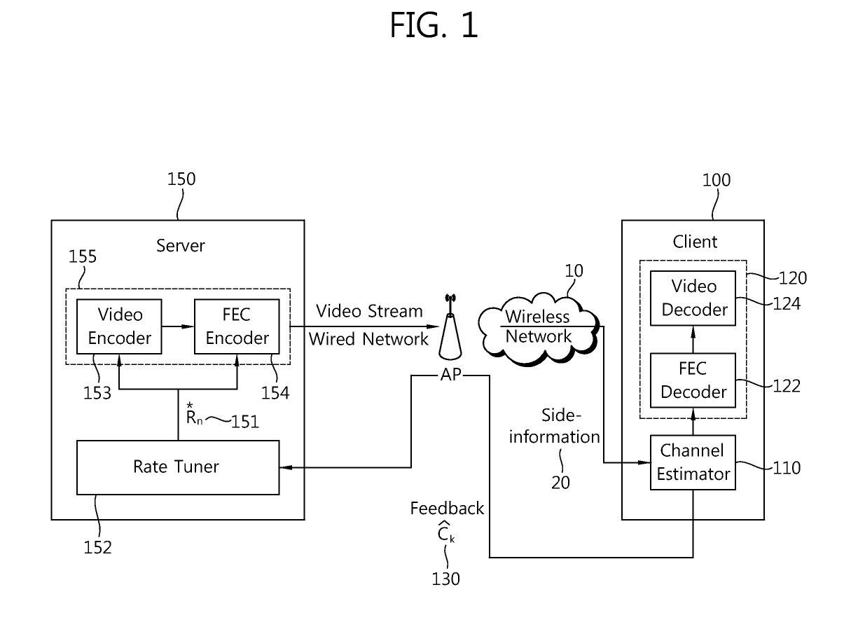

FIG. 1 is a block diagram describing rate adaptation in a wireless network according to an exemplary embodiment of the present invention.

Referring to FIG. 1, a client terminal 100 estimates current channel capacity of a wireless network using a bit error rate (BER) estimate as represented by the following Equation 1 to transmit the estimated channel capacity to a server 200, in order to provide improved video quality. After an entropy average value during a single video adaptation period is calculated, channel capacity \tilde{C}ₙ^{CLDS} may be estimated using the entropy average value.

$${\tilde{C}}_{n}^{CLDS} = 1 - \frac{1}{m} {\sum }_{i = 1}^{m} {H}_{b} ( \tilde{{ɛ}_{i}} ) \qquad Equation 1$$

Where \tilde{ε}hd i indicates a BER estimate for a packet i, and H_{B}(\tilde{ε}ᵢ) indicates instantaneous entropy for each packet. That is, H_{b}(\tilde{ε}ᵢ) means entropy for each estimated BER. The single video adaptation period may include m packets and be about five seconds. See Korean Patent Laid-Open Publication No. 10-2009-0071005 previously filed by the present applicant with respect to a detailed process of calculating the channel capacity using the above Equation 1.

A method of calculating the BER estimate using side information according to the exemplary embodiment of the present invention will be described below.

The client terminal 100 includes a channel estimator 110 and a decoding unit 120. The decoding unit 120 may include a forward error correction (FEC) decoder 120 and a video decoder 130.

The channel estimator 110 estimates a BER using side information on received video packets and estimates current channel capacity or a channel condition of a wireless network using the estimated BER.

The decoding unit 120 sets a channel coding rate based on the estimated channel capacity 130 or channel condition to perform channel-coding on the video packets received through the wireless network 10 and decode the video on which the channel-coding is performed. More specifically, the FEC decoder 120 sets an appropriate channel coding rate using the estimated channel capacity or channel condition to perform the channel-coding on the vide received through the wireless network, and the video decoder 130 decodes the video on which the channel-coding is performed.

A server 150 includes a rate tuner 151 and an encoding unit 155. The encoding unit 155 includes a video encoder 153 and an FEC encoder 154.

The server 150 predicts an optimal video/channel rate or source/channel rate according to Equation 2 using a fed-back channel capacity estimate 130.

The rate tuner 151 optimally tunes a video coding rate of the video encoder 152 and a channel coding rate of the FEC encoder using the estimated channel capacity 130 fed-back from the client terminal 100.

The encoding unit 155 encodes video data according to a predetermined video coding rate and channel-encodes the encoding result of the video according to a predetermined channel coding rate to transmit the channel-encoding result to the client terminal 100. More specifically, the video encoder 153 encodes the video data according to a predetermined video coding rate, and the FEC encoder 154, which is a kind of channel encoder for correcting a channel error, performs the channel-encoding on the encoding result of the video according to a predetermined channel coding rate. A video stream is generated through the video encoder 153 and the FEC encoder 154.

At the time of the channel-coding, a differential rate is applied according to characteristics of a video frame using an LDPC code, thereby making it possible to minimize video quality distortion generated at the time of an error of transmission through the wireless network.

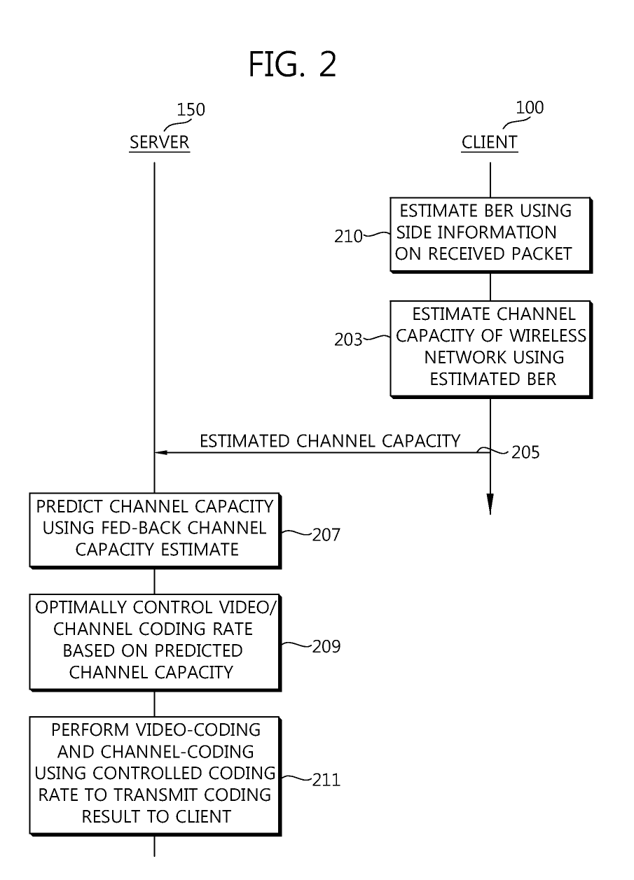

FIG. 2 is a flow chart describing a wireless channel condition estimating method performed in a client apparatus and a coding rate controlling method in a wireless network performed in a server according to the exemplary embodiment of the present invention.

Referring to FIG. 2, the client apparatus 100 first estimates a BER using side information on received video packets (S201) and estimates channel capacity of a wireless network using the estimated BER (S203). Here, since the channel capacity of the wireless network may be more accurately estimated when the BER is accurately estimated, it is required to accurately estimate the BER. According to the present invention, a method of estimating a BER using side information is provided. According to the exemplary embodiment of the present invention, the side information may include wireless network information on the wireless network connected to the client apparatus 100, modulation scheme information, and signal strength information. According to another exemplary embodiment of the present invention, the side information may include signal strength information. According to still another exemplary embodiment of the present invention, the side information may include maximum signal strength information, minimum signal strength information, and signal strength section information. According to still another exemplary embodiment of the present invention, the side information may further include the number of packets of a wireless channel, in addition to the signal strength information. The wireless network information, the modulation scheme information, and the signal strength information included in the side information will be described below.

The side information may be provided from a PHY layer and/or an MAC layer of the client apparatus.

The client apparatus 100 feeds back the estimated channel capacity to the server 150 (S205). According to another exemplary embodiment of the present invention, the client apparatus 100 may also feed back the side information to the server 150.

The server 150 predicts channel capacity using the fed-back estimated channel capacity (S207), controls a video coding rate and a channel coding rate based on the predicted channel capacity (S209), and encodes video data using the controlled video coding rate and channel-codes the encoding result of the video using the controlled channel coding rate to transmit the channel-coding result to the client apparatus 100 (S211).

The server 150 predicts an optimal video/channel coding rate or an optimal source/channel coding rate according to a function of the following Equation 2.

That is, a Q′(.) function (empirical Rate Distortion (RD) for above-capacity video) is used, thereby making it possible to more accurately predict the optimal video/channel coding rate or the optimal source/channel coding rate.

$${{R}_{n}^{OP}}^{*} = {argmax}_{{R}_{n}^{OP} ( 0 \leq {R}_{n}^{OP} \leq 1 )} Q ( {R}_{n}^{OP} T ) \cdot \frac{{\int }_{{R}_{n}^{OP} - {{C}_{n}^{OP}}^{⋒}}^{1 - {{C}_{n}^{OP}}^{⋒}} \frac{1}{\sqrt{2 π} {σ}_{e}} exp ( \frac{- {e}_{n}^{2}}{2 {σ}_{e}^{2}} ) d e}{{\int }_{- {{C}_{n}^{OP}}^{⋒}}^{1 - {{C}_{n}^{OP}}^{⋒}} \frac{1}{\sqrt{2 π} {σ}_{e}} exp ( \frac{- {e}_{n}^{2}}{2 {σ}_{e}^{2}} ) d e} + {Q}^{′} ( \frac{{R}_{n}^{OP} - {C}_{n}^{OP}}{{R}_{n}^{OP}} ) \cdot \frac{{\int }_{{R}_{n}^{OP} - {{C}_{n}^{OP}}^{⋒}}^{1 - {{C}_{n}^{OP}}^{⋒}} \frac{1}{\sqrt{2 π} {σ}_{e}} exp ( \frac{- {e}_{n}^{2}}{2 {σ}_{e}^{2}} ) d e}{{\int }_{- {{C}_{n}^{OP}}^{⋒}}^{1 - {{C}_{n}^{OP}}^{⋒}} \frac{1}{\sqrt{2 π} {σ}_{e}} exp ( \frac{- {e}_{n}^{2}}{2 {σ}_{e}^{2}} ) d e} \qquad Equation 2$$

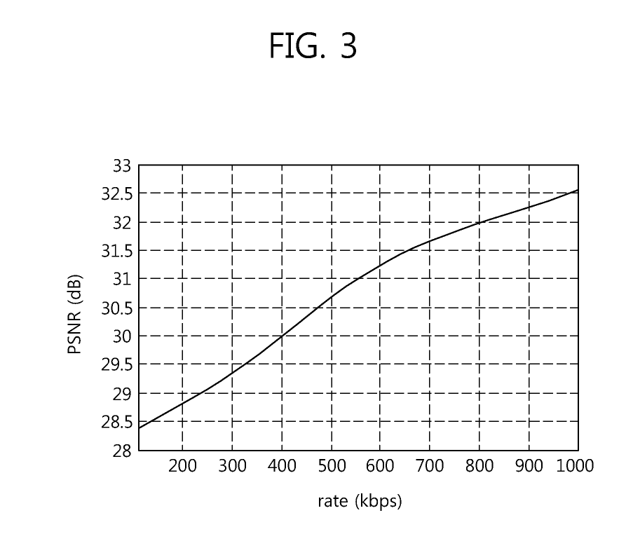

Q′(.) indicates a rate distortion (RD) function of a video (See FIG. 3), which may be obtained at the time of encoding the video.

Q′(.) indicates a video quality distortion estimating function according to excess of channel capacity.

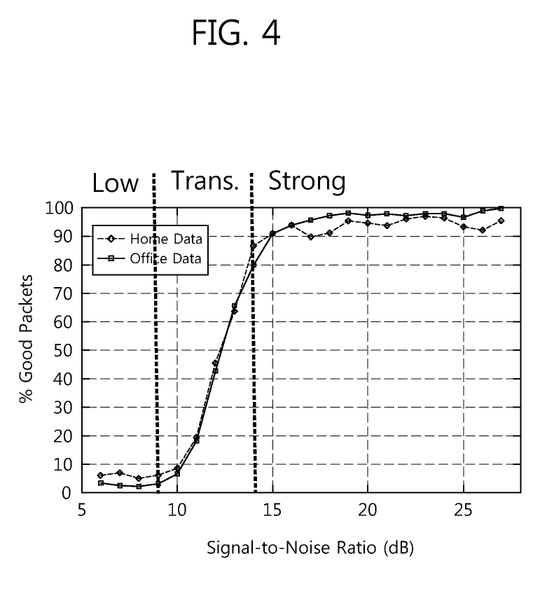

Q′(.) uses f(x)−ax^{b}+c, 0≦x≦0.12.

Where a=−1.18×10², b=2.148, and c=0.9898 (See FIG. 4). The above values may be obtained through an experiment. Therefore, the above values may be changed according to the video data, but do not have a large error. Particularly, when this value is replaced by 0, a more accurate value may be predicted.

x indicates a difference

$$( \frac{{R}_{n}^{op} - {C}_{n}^{op}}{{R}_{n}^{op}} )$$

between a rate to be predicted and channel capacity. That is, as the difference increases, distortion of the video quality increases.

The Gaussian distribution is prediction error probability distribution.

Therefore, in Equation 1, an optimal rate is a value at which a combination of Q(.), Q′(.), and rate prediction error probability distribution becomes best.

See Korean Patent Laid-Open Publication No. 10-2009-0071005 previously filed by the present applicant with respect to a detailed process of calculating the optimal video/channel coding rate or the optimal source/channel coding rate using the above Equation 2.

The server 150 may apply a differential rate according to characteristics of a video frame using an LDPC code.

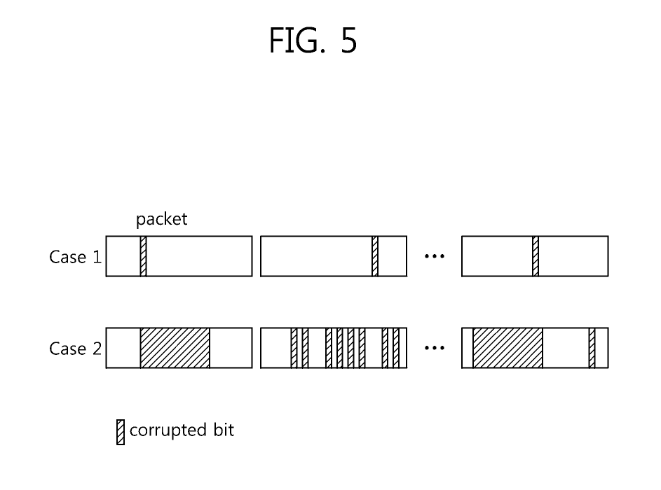

Performance of the LDPC code is changed according to a length of the packet and a value of a (See the following description) (See FIG. 5).

In addition, the encoded video frames have different importance according to a kind thereof. That is, when an I frame is not present, a P or B frame may not be decoded. Therefore, packets (lengths of each packet are different) including the I-frame is channel-coded by applying an a value capable of being certainly decoded in the client terminal 100 thereto (that is, more redundant bits are provided to be more error-robust). For example, an I-frame packet having a length of 800 bits may be channel-coded by applying an a value of 2.7 thereto.

After the I-frame packet is channel-coded, a P-frame packet is channel-coded by applying an a value thereto according to the following Equation 3 (See Equation 5).

$${α}_{P} = \frac{∝ {\sum }_{i = 1}^{N} {L}_{i} - {\sum }_{i = 1}^{k} {∝}_{i}^{I} {L}_{i}^{I}}{{\sum }_{i = k + 1}^{N} {L}_{i}^{P}} \qquad Equation 3$$

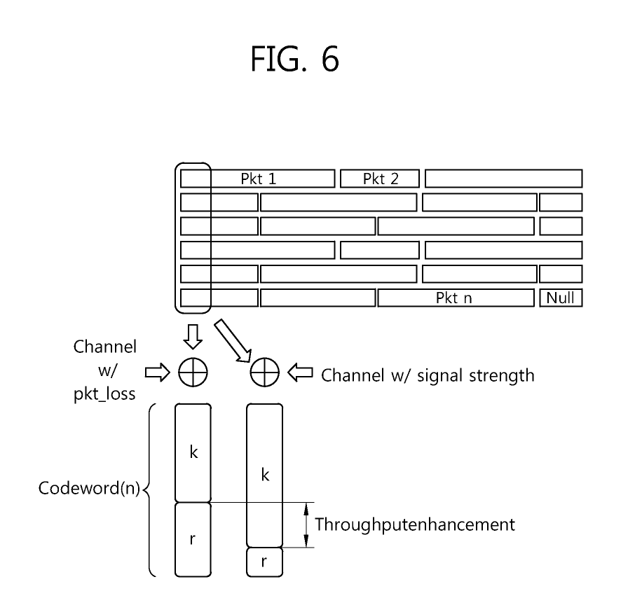

In the above Equation 2, R^{op} indicates an operation rate. The fact that all existing channel codes have performance lower than that of channel capacity is well known. Therefore, a decrease in performance is present according to the performance of the channel code. As a result, an a value is applied as represented by the following Equation 4. In the case of an ideal channel code, α is 1. Generally, according to an experimental result, α is about 2.0 or more (See FIG. 6).

$${R}_{n}^{op} = 1 - α \cdot H ( ɛ ) , 1 \leq α \leq \frac{1}{H ( ɛ )} \qquad ( 4 )$$

A total redundant bit is calculated through Equation 2, which may be rearranged as represented by Equation 5.

$$α \cdot H ( ɛ ) \cdot {\sum }_{i = 1}^{n} {L}_{i} = H ( ɛ ) \cdot {\sum }_{i = 1}^{k} {α}_{i}^{I} {L}_{i}^{I} + {α}_{P} \cdot H ( ɛ ) \cdot {\sum }_{i = k + 1}^{n} {L}_{i}^{P} \qquad ( 5 )$$

A video quality result (ORPA_{CLDS}) in a terminal using the method (1) and the method (2) is as follows. ORPA_{CON} indicates current 802.11b protocol performance. Video quality may be improved by 6 dB or more.

TABLE 1
Rate adaptation performance comparison in terms of video quality in dB

| | Xmit | Operational | | |
|---|---|---|---|---|
| Phy | Rate | Channel | ORPACLDS | ORPACON |
| (Mbps) | (Kbps) | (PSNR-dB) | (dB) | (dB) |
| 2 | 500 | 28.96 | 27.67 | 27.81 |
| | 750 | 31.02 | 30.74 | 30.78 |
| | 900 | 31.93 | 31.51 | 31.25 |
| | 1024 | 32.52 | 32.43 | 32.31 |
| | avg | 31.11 | 30.59 | 30.53 |
| 5.5 | 500 | 29.00 | 27.92 | 28.23 |
| | 750 | 30.88 | 29.39 | 29.84 |
| | 900 | 31.90 | 30.78 | 29.98 |
| | 1024 | 32.47 | 32.38 | 30.95 |
| | avg | 31.06 | 30.11 | 29.75 |
| 11 | 500 | 29.00 | 27.59 | 25.22 |
| | 750 | 30.88 | 29.53 | 30.18 |
| | 900 | 31.78 | 30.67 | 22.73 |
| | 1024 | 31.99 | 30.12 | 15.01 |
| | avg | 30.91 | 29.47 | 23.28 |

In Table 1, Xmit Rate indicates a transmit rate of video data, an operation channel indicates an actually possible maximum value of PSNR in the case of transmitting the video data, ORPA_{CLDS j}indicates performance of the case of applying a protocol estimating a channel condition using side information including signal strength information according to the exemplary embodiment of the present invention, and ORPA_{CON} indicates performance of the case of the WLAN 802.11b protocol according to the related art (here, ORPA means an optimal rate prediction architecture). Referring to Table 1, in the case in which Phy data rate is low (2 or 5.5 Mbps), referring to performance in the case of an average transmit rate (avg) of Table 1, it was shown that a large difference is not present between performance (30.63 dB and 29.75 dB) of ORPA_{CON} according to the related art and performance (30.69 dB and 30.11 dB) of ORPA_{CLDS} according to the exemplary embodiment of the present invention. However, in the case in which Phy data rate is high (11 Mbps), referring to the performance in the case of the average transmit rate (avg) of

Table 1, it could be appreciated that a large difference of 6 dB or more is present between performance (23.28 dB) of ORPA_{CON} according to the related art and performance (29.47 dB) of ORPA_{CLDS} according to the exemplary embodiment of the present invention, which indicates that the performance is significantly improved in the exemplary embodiment of the present invention.

In the exemplary embodiment of the present invention described above, the method of estimating and predicting a channel condition using signal strength information in a wireless network has been suggested (See Table 1). Here, the signal strength information and information on the number of packets in wireless may be included in the side information.

Meanwhile, in the case of using signal strength information of received video packets in order to estimate a bit error rate (BER) for video packets transmitted in real time, since a maximum point and a minimum point of signal strength in different wireless channels are changed according to a wireless network such as WLAN IEEE 802.11b, IEEE 802.11a, or the like, absolute signal strength information does not have an important meaning. Therefore, standardized signal strength information that is not changed according to the wireless network such as WLAN IEEE 802.11b, IEEE 802.11a, or the like, is required.

Therefore, in another exemplary embodiment of the present invention, a standardized format of side information may be defined and used as follows (See Table 2 and FIG. 4).

TABLE 2

| | # of | |
|---|---|---|
| | bits | Description |
| Max | 8 bits | The maximum signal strength of an operating channel |
| Min | 8 bits | The minimum signal strength of an operating channel |
| Region | 2 bits | It indicates whether signal is in Low, Transition or |
| Type | | Strong region. |
| Signal | 6 bits | Normalized signal strength in dB |
| Strength | | |

Referring to Table 2 and FIG. 4, in the case in which the maximum point and the minimum point of the signal strength are changed according to the wireless network such as WLAN IEEE 802.11b, IEEE 802.11a, or the like, the side information may include maximum signal strength information, minimum signal strength information, signal strength section information (Region type Low, Transition, Strong), and 6 bits of normalized signal strength information. More specifically, in the case in which the maximum point and the minimum point of the signal strength are changed according to the wireless network such as WLAN IEEE 802.11b, IEEE 802.11a, or the like, maximum signal strength information and minimum signal strength information are detected in signal strengths of video packets received during a predetermined adaptation period, representative signal strength information is estimated with respect to the video packets received during the predetermined adaptation period, the signal strength section is divided into a plurality of sections including at least one transition section, and to which of the divided signal strength sections (Low, Transition, Strong) the representative signal strength for the video packets received during the predetermined adaptation period corresponds is determined to generate the signal strength section information.

According to still another exemplary embodiment of the present invention, as a format of the standardized side information (signal strength information), the following modified formats may also be used.

TABLE 3

| | # of | |
|---|---|---|
| | bits | Description |
| Max | 8 bits | The maximum signal strength of an operating channel |
| Min | 8 bits | The minimum signal strength of an operating |
| | | channelRegion |
| Region | 2 bits | It indicates whether signal is in Low, Transition or |
| Type | | Strong region. |
| Reserved | 6 bits | Reserved bits |
| Signal | 8 bits | Signal strength in dB |
| Strength | | |

Table 3 is different from Table 2 in that 6 bits are further included as reserved bits and 8 bits rather than 6 bits are used as signal strength information. The number of bits used in each information included in the side information used in Table 2 and Table 3 is not limited to values of Table 2 and Table 3, but may be variously changed.

The signal strength information of Table 2 and Table 3 as described above is used to be fed-back together with the numbers of packet losses, jitters, and packet delays to the server (for example, using RTCP) and is used to predict the most appropriate source coding rate and channel coding rate in a rate adaptation application, thereby making it possible to improve performance in terms of video quality (PSNR) in a wireless environment.

In addition, research has revealed that the number of packets (the number of background traffic) on a wireless channel also assists in prediction of the wireless channel. In still another exemplary embodiment of the present invention, information on the number of packets on the wireless channel may be formatted as represented by the following Table 4 and be additionally included in the side information.

TABLE 4

| | # of bits | Description |
|---|---|---|
| The number of | 16 bits | The number of packets not interested by |
| background traffic | | a specified client |

Max8 bits The maximum signal strength of an operating channel Min8 bits The minimum signal strength of an operating channel Region Region Type2 bits It indicates whether signal is in Low, Transition or Strong region. Reserved6 bits Reserved bits Signal Strength8 bits Signal strength in dB.

The side information (for example, the signal strength information, the information on the number of packets on the wireless channel, or the like) provided from an MAC layer of the wireless client terminal may be used as an input for reducing a calculation amount of an application FEC such as LDPC and be fed-back to the server to thereby be used as important information in predicting the optimal source coding rate and channel coding rate in the server.

In still another exemplary embodiment of the present invention, the side information may be defined and used as a standardized format as represented by the following Table 5.

TABLE 5

| | # of bits | Description |
|---|---|---|
| Wireless network | 6 bits | Operating wireless network, e.g., 802.11a, |
| | | WiMax |
| Modulation type | 6 bits | Modulation scheme, e.g, BPSK, QPSK, |
| | | 16-QAM |
| Reserved | 6 bits | Reserved |
| Signal to Noise | 8 bits | Signal strength in dB |
| Ratio (SNR) | | |

Referring to Table 5, the side information may include wireless network information ((WLAN IEEE 802.11b, IEEE 802.11a, WiMax, or the like), modulation scheme information (BPSK, QPSK, 16-QAM, or the like), and signal strength information.

FIGS. 6 to 8 show a correlation between BER and SNR in 802.11a, 802.11g, WiMax wireless networks. Since each wireless network is designed based on the above information, the above information may be provided from each network.

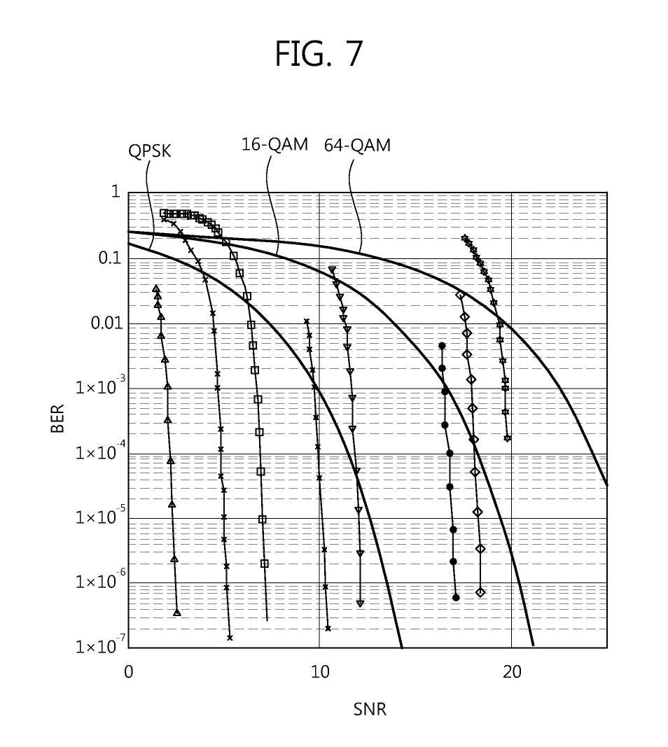

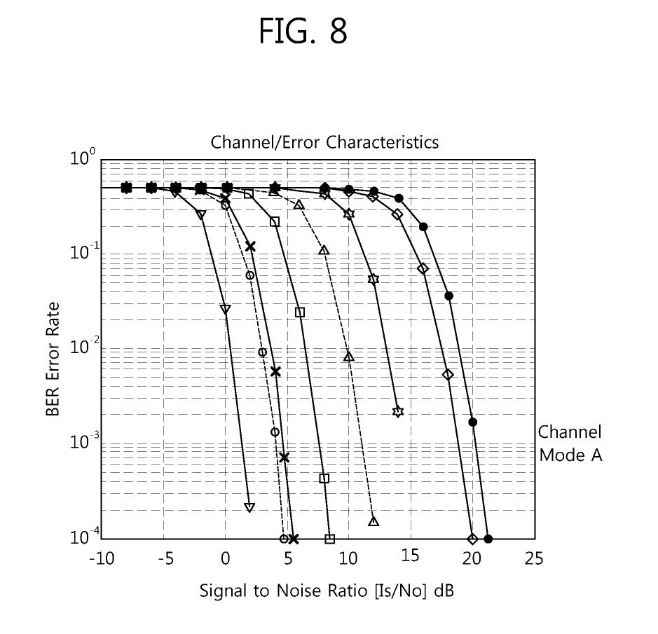

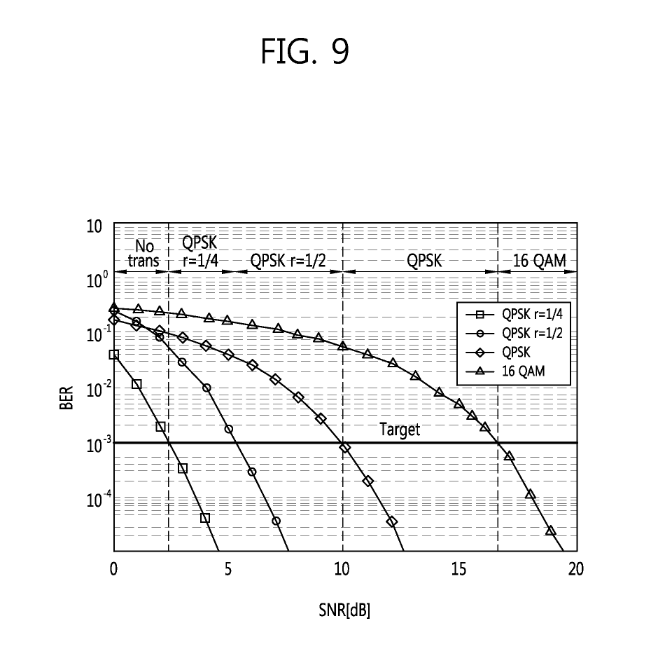

That is, FIG. 6 shows a correlation between BER and SNR according to a physical modulation scheme (QPSK, 16-QAM, and 64-QAM) in the 802.11a wireless network, FIG. 7 shows a correlation between BER and SNR according to a physical modulation scheme (QPSK, 16-QAM, and 64-QAM) in the 802.11g wireless network, and FIG. 8 shows a correlation between BER and SNR according to a physical modulation scheme (QPSK and 16-QAM) in the WiMax wireless network.

Referring to FIGS. 6 to 8, it could be appreciated that there is a correlation between BER and SNR according to a kind of wireless networks (WLAN IEEE 802.11b, IEEE 802.11g, WiMax, or the like), a modulation scheme (BPSK, QPSK, 16-QAM, or the like), and signal strength (dB).

That is, when it is recognized to what wireless network by what modulation method the client terminal is connected, the client terminal may more accurately estimate a bit error rate (BER) using an SNR value present in MAC/PHY layers, as compared to the case according to the related art and more accurately estimate channel capacity based on the more accurately estimated BER, and the server may control a source coding rate and a channel coding rate so as to become more optimal value, based on the estimated channel capacity. In the case of predicting the channel condition using the side information including the wireless network information (WLAN IEEE 802.11b, IEEE 802.11a, WiMax, or the like), the modulation scheme information (BPSK, QPSK, 16-QAM, or the like), and the signal strength information according to another exemplary embodiment of the present invention described above, since the prediction value is more accurate as compared with the case of using a channel condition prediction value only using an existing packet error rate (PER), more throughput may be generated. As a result, PSNR may be improved, and quality of the received video packets may be improved.

FIG. 5 is a conceptual diagram showing a case in which packet loss and a bit error are present with respect to wireless channels of Case 1 and Case 2. Referring to FIG. 5, in the case of the WLAN protocol according to the related art, for example, the WLAN 802.11b protocol, since FEC through retransmission is similarly performed in both of Case 1 and Case 2 regardless of whether or not the number of error bits of wireless channels of Case 1 and Case 2 is 3, 10, or 100 and FEC is performed based on PER without distinguishing the wireless channels of Case 1 and Case 2 from each other, characteristics of the wireless channels of Case 1 and Case 2 cannot be captured only with the number of packet loss information, and thus it is recognized that the wireless channels of Case 1 and Case 2 have the same channel capacity. On the other hand, in the case of the exemplary embodiments of the present invention, since BER is more accurately estimated using the above-mentioned side information to estimate the channel capacity, characteristics of the wireless channels of Case 1 and Case 2 are distinguished from each other in terms of BER, such that it may be recognized that the wireless channels of Case 1 and Case 2 have different channel capacities, thereby making it possible to improve accuracy of the channel capacity estimation.

FIG. 6 is a conceptual diagram in which a case of using only information on the number of packet losses is compared with a case of using signal strength information in terms of throughput improvement in the case of applying FEC to packets of Case 1 of FIG. 5. It could be appreciated from FIG. 6 that in the case of applying the FEC to packets transmitted through a wireless channel of Case 1 in an interleaving scheme, redundancy bits (r) in a codeword (k: information bit; r: redundancy bit) is reduced in the case of using the signal strength information as compared to the case of using only the information on the number of packet losses, such that throughput is improved.

1. A wireless channel condition estimating method in a wireless network, the method being performed in a client apparatus connected to a server that transmits video packet stream through a wired or wireless network, the method comprising:
estimating a bit error rate (BER) using side information on received video packet; and
estimating channel capacity of the wireless network using the estimated BER,
wherein the side information includes signal strength information, modulation scheme information and wireless network information on the wireless network connected to the client apparatus.

2. The wireless channel condition estimating method of claim 1, wherein the signal strength information is provided from at least one of a PHY layer and an MAC layer of the client apparatus.

3. The wireless channel condition estimating method of claim 2, wherein the estimated channel capacity is fed-back from the client apparatus to the server.

4. The wireless channel condition estimating method of claim 3, wherein the server predicts the channel capacity using the fed-back estimated channel capacity and controls a video coding rate and a channel coding rate based on the predicted channel capacity.

5. The wireless channel condition estimating method of claim 1, further comprising:
detecting maximum signal strength information and minimum signal strength information in signal strengths of video packets received during a predetermined adaptation period;
estimating representative signal strength information with respect to the video packets received during the predetermined adaptation period;
dividing the signal strength section into a plurality of sections including at least one transition section; and
determining that the representative signal strength for each of the video packets received during the predetermined adaptation period belongs to which of the divided signal strength sections such that a signal strength section information is generated.

6. The wireless channel condition estimating method of claim 5, wherein the maximum signal strength information, the minimum signal strength information, the representative signal strength information, and the generated signal strength section information are included in the side information.

7. The wireless channel condition estimating method of claim 5, wherein the side information further includes information on the number of packets transmitted through the wireless network.

8. The wireless channel condition estimating method of claim 1, wherein the side information is fed-back from the client apparatus to the server.

9. A client apparatus, connected to a server that transmits video packet stream through a wired or wireless network, for estimate a wireless channel condition in a wireless network, the client apparatus comprising:
a channel estimator configured to estimate a bit error rate (BER) using side information on received video packet and configured to estimate channel capacity of the wireless network using the estimated BER; and
a decoding unit configured to set a channel coding rate based on the estimated channel capacity to perform channel-coding on the video packets received through the wireless network and decode the video on which the channel-coding is performed,
wherein the side information includes signal strength information, modulation scheme information and wireless network information on the wireless network connected to the client apparatus.

10. The client apparatus of claim 9, wherein the signal strength information is provided from at least one of a PHY layer and an MAC layer of the client apparatus.

11. The client apparatus of claim 10, wherein the estimated channel capacity is fed-back from the client apparatus to the server.

12. The client apparatus of claim 11, wherein the server predicts the channel capacity using the fed-back estimated channel capacity and controls a video coding rate and a channel coding rate based on the predicted channel capacity.

13. The client apparatus of claim 9, wherein the channel estimator detects maximum signal strength information and minimum signal strength information in signal strengths of video packets received during a predetermined adaptation period, estimates representative signal strength information with respect to the video packets received during the predetermined adaptation period, divides the signal strength section into a plurality of sections including at least one transition section, and determines that the representative signal strength for each of the video packets received during the predetermined adaptation period belongs to which of the divided signal strength sections such that a signal strength section information is generated.

14. The client apparatus of claim 13, wherein the maximum signal strength information, the minimum signal strength information, the representative signal strength information, and the generated signal strength section information are included in the side information.

15. The client apparatus of claim 13, wherein the side information further includes information on the number of packets transmitted through the wireless network.

16. A coding rate controlling method in a wireless network, the method being performed in a server, connected to a client apparatus through a wired or wireless network, to transmit video packet stream, the method comprising:
receiving estimated channel capacity fed-back from the client apparatus to predict channel capacity using the fed-back estimated channel capacity; and
controlling a video coding rate and a channel coding rate based on the predicted channel capacity,
wherein the estimated channel capacity is estimated using side information including signal strength information, modulation scheme information and wireless network information on the wireless network connected to the client apparatus.

17. The coding rate controlling method of claim 16, wherein the signal strength information is provided from at least one of a PHY layer and an MAC layer of the client apparatus.
